(19) United States
(12) Patent Application Publication
(10) Pub. No.: US 2020/0066125 A1
(43) Pub. Date: Feb. 27, 2020

(54) FIRE ALARM BUILDING MANAGEMENT INTEGRATION

(71) Applicant: TYCO FIRE & SECURITY GMBH, Neuhausen Am Rheinfall (CH)

(72) Inventors: Alan J. BOGUSLAWSKI, Gardner, MA (US); Gary VINCENT, Neuhausen am Rheinfall (CH); Joseph D. FARLEY, Warwick, MA (US); Michael A. FURTADO, Shrewsbury, MA (US); Andreas BRENNER, Höhenkirchen-Siegertsbrunn (DE)

(21) Appl. No.: 16/609,804

(22) PCT Filed: May 1, 2018
(86) PCT No.: PCT/IB2018/053001

§ 371 Date: Oct. 31, 2019

Related U.S. Application Data
(60) Provisional application No. 62/492,418, filed on May 1, 2017.

(51) Int. Cl. G08B 17/00; G08B 25/00; G08B 25/08; G08B 25/10

(52) U.S. Cl. CPC G08B 17/00; G08B 25/10; G08B 25/085; G08B 25/004

(57) ABSTRACT

A fire alarm system includes an alarm panel, one or more notification appliances, one or more initiating devices, one or more wires, and one or more alternate building systems. The one or more wires couple the alarm panel to the one or more notification appliances and to the one or more initiating devices. The one or more alternate building systems are coupled to the one or more wires. The one or more alternate building systems each include one or more components configured to receive power from the one or more wires.

### CROSS-REFERENCE TO RELATED APPLICATIONS

The present disclosure claims the benefit of and priority to U.S. Provisional Application No. 62/492,418, titled “FIRE ALARM BUILDING MANAGEMENT INTEGRATION,” filed May 1, 2017, the disclosure of which is incorporated herein by reference in its entirety.

### TECHNICAL FIELD

The present disclosure relates generally to the field of alarm systems, and more particularly to an improved system and method for providing an integrated system wherein the fire alarm system may share wiring with other, alternate systems located in the building.

### BACKGROUND

Fire alarm systems typically include one or more alarm panels that receive information from various sensors that are distributed throughout a monitored structure or area. For example, a typical fire alarm system may include an alarm panel that is installed at a central location within a building. The alarm panel may be operatively connected to a plurality of initiating devices (e.g., smoke detectors, manually-actuated pull stations, etc.) that are distributed throughout respective areas of the building.

During normal operation of the alarm system, the alarm panel may monitor electrical signals associated with each of the respective initiating devices connected thereto for variations that may represent the occurrence of an alarm condition. For example, a variation in a particular electrical signal may represent the detection of smoke by a smoke detector in a corresponding area of the building in which the smoke detector is located, and may cause the alarm panel to enter an alarm mode. The alarm panel may be configured to respond to such a condition by initiating certain predefined actions, such as by activating one or more notification appliances (e.g. strobes, sirens, public announcement systems, etc.) that are installed throughout the building and that are associated with the initiating device that detected the alarm condition.

In a building, for example, a commercial building, residential building, high-rise building, etc., the installation of the plurality of initiating devices and the notification appliances may include the running of a large quantity of wiring between the various devices and the central alarm panel. In addition, when one considers that a building may also include other, alternate building systems such as, for example, HVAC (humidity, temperature), security, motion, cameras, and efficiency tools such as pedestrian traffic monitors and lighting controls (and light sensors), large quantities of wiring may be required in any one building.

Current fire alarm systems operate largely independently from these other, alternate building systems. In turn, this may result in costly duplication of infrastructure, which is problematic both from an installation perspective and from a maintenance perspective. Separate wiring for all the different systems may dramatically increase the cost of installation for all the systems. In addition, different personnel are required to maintain the various systems. This is so, even though much of the wiring is run in the same general area and with the same general electrical requirements (e.g., low voltage wiring, similar distances, etc.). In addition, maintenance of the various alternate systems often requires knowledge and skills that are equivalent.

### SUMMARY

One implementation of the present disclosure is a fire alarm system. The fire alarm system includes an alarm panel, one or more notification appliances, one or more initiating devices, one or more wires, and one or more alternate building systems. The one or more wires couple the alarm panel to the one or more notification appliances and to the one or more initiating devices. The one or more alternate building systems are coupled to the one or more wires. The one or more alternate building systems each include one or more components configured to receive power from the one or more wires.

Another implementation of the present disclosure is a method of operating a fire alarm system. The method includes receiving, at one or more alternate building systems, power from one or more wires, the one or more wires coupled to the one or more alternate building systems, the one or more wires coupling an alarm panel to one or more notification appliances and to one or more initiating devices. The method includes communicating, by the one or more alternate building systems, communication information over the one or more wires to the alarm panel.

### BRIEF DESCRIPTION OF THE DRAWINGS

By way of example, a specific embodiment of the disclosed device will now be described, with reference to the accompanying drawings, in which:

FIG. 1 is an exemplary fire alarm system;

FIG. 2 is an exemplary embodiment of a power interface that may be used in connection with an integrated solution according to one embodiment of the present disclosure;

FIG. 3 is an exemplary embodiment of a wireless communication scheme that may be used in connection with the integrated solution according to one embodiment of the present disclosure; and

FIG. 4 is an exemplary embodiment of a wired communication scheme that may be used in connection with the integrated solution according to one embodiment of the present disclosure.

### DETAILED DESCRIPTION

Embodiments of an integrated system in accordance with the present disclosure will now be described more fully hereinafter with reference to the accompanying drawings, in which illustrative embodiments of the present disclosure are presented. The disclosed integrated system of the present disclosure may, however, be embodied in many different forms and should not be construed as being limited to the embodiments set forth herein. Rather, these embodiments are provided so that this disclosure will convey certain example aspects of the integrated system to those skilled in the art.

The present disclosure concerns a solution to integrate various building systems with a fire alarm system, both from a physical infrastructure perspective, and from a functional perspective. According to an embodiment of the present disclosure, systems would share wiring as well as some level of intelligence.

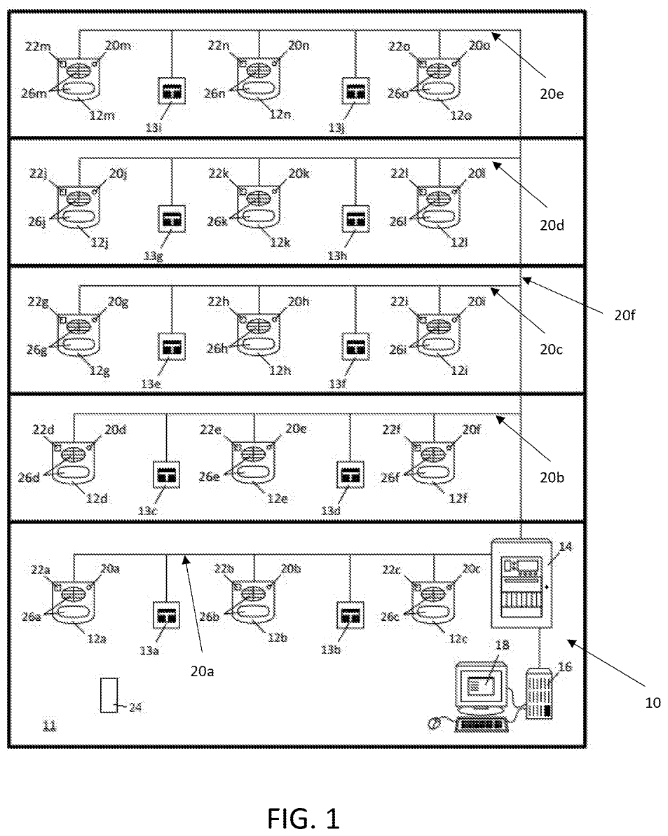

Referring to FIG. 1, an exemplary alarm system 10 in accordance with the present disclosure is shown. The alarm system may be installed in a multi-story building 11, for example. The alarm system 10 may include a plurality of notification appliances 12a-o and a plurality of initiating devices 13a-j that may be installed throughout the building 11 and connected to one or more alarm panels 14. Each notification appliance 12a-o and initiating device 13a-j may be associated with a unique address within the alarm system 10 for facilitating identification thereof by the alarm panel 14 and enabling selective routing of command/control signals from the alarm panel 14 to each notification appliance 12a-o and initiating device 13a-j. The exemplary alarm system 10 includes three notification appliances and two initiating devices located on each floor of the building 11, but it is to be understood that the alarm system 10 may include a greater or fewer number of notification appliances and/or initiating devices disposed in numerous configurations within a structure or area without departing from the scope of the present disclosure.

The notification appliances 12a-o may be configured to provide notification of an alarm condition within the building 11 upon manual or automatic actuation of one or more of the initiating devices 13a-j in the alarm system 10. Particularly, each initiating device 13a-j may be associated with one or more of the notification appliances 12a-o such that actuation of each initiating device 13a-j will result in the activation of respective, associated notification appliance(s) 12a-o. For example, each of the initiating devices 13a-b located on the first floor of the building 11 may be associated with all the notification appliances 12a-f located on the first two floors of the building 11. It will be appreciated that many other combinations and permutations of associations between the notification appliances 12a-o and initiating devices 13a-j in the system exist. All such combinations and permutations are contemplated and may be implemented without departing from the scope of the present disclosure.

The notification appliances 12a-o shown in FIG. 1 are strobe/horn units, but it is contemplated that other varieties of notification appliances, including, but not limited to, bells, buzzers, etc., may additionally or alternatively be implemented in the alarm system 10 in a similar manner. The initiating devices 13a-j shown in FIG. 1 are manually-actuated pull stations, but it is contemplated that other varieties of manually or automatically actuated initiating devices, including, but not limited to smoke detectors, heat detectors, carbon monoxide detectors, motion detectors, etc., may additionally or alternatively be implemented in the alarm system 10 in a similar manner.

In some embodiments, one or more notification appliances 12a-o is co-located with one or more initiating devices 13a-j. For example, the one or more initiating devices 13a-j may include a sensor (e.g. smoke detectors, heat detectors, carbon monoxide detectors, motion detectors, etc.) which can be in a same housing as the one or more notification appliances 12a-o. The one or more initiating devices 13a-j may be coupled to a same backplane as the one or more notification appliances 12a-o, which can allow for reduced wiring requirements. In some embodiments, the one or more initiating devices 13a-j are removably mounted to the backplane, facilitating replacement and upgrade.

The exemplary alarm system 10 may also include a workstation 16, such as a personal computer (PC) or server, which is operatively connected to the alarm panel 14. The workstation 16 may be loaded with one or more software applications that provide human operators of the system 10 with a user interface 18 for monitoring and controlling certain aspects of the alarm system 10. For example, the user interface 18 may allow an operator to observe the functional status of the notification appliances 12 and initiating devices 13, and to activate, deactivate, observe the functional status of, or otherwise exert control over the notification appliances 12a-o and initiating devices 13a-j as further described below. In some embodiments, the workstation 16 and user interface 18 may be omitted from the alarm system 10, and an operator may activate, deactivate, observe the functional status of, or otherwise exert control over the notification appliances 12a-o and initiating devices 13a-j via the alarm panel 14.

Each of the notification appliances 12a-o may be equipped with one or more verification indicia 20a-o. The verification indicia 20a-o may be configured to be activated upon the actuation of respective, associated initiating devices 13a-j as further described below. The verification indicia 20a-o may include any type of visual indicia that are capable of being activated in response to an electrical signal, including, but not limited to, light emitting diodes (LEDs), incandescent light bulbs, fluorescent light bulbs, liquid crystal displays (LCDs), Electronic flashtubes (Xenon), strobes, and the like. Such visual indicia 20a-o may be prominently located on the exteriors of the notification appliances 12. The verification indicia 20a-o may include any type of audible indicia that are capable of being activated in response to an electrical signal, including, but not limited to, sirens, horns, bells, buzzers, speakers, and the like.

Each of the notification appliances 12a-o may be further provided with a manually actuated input device 22a-o, such as a switch or a button. The input devices 22a-o may be configured such that actuation of an input device 22a-o may cause a previously activated verification indicium 20a-o of a respective notification appliance 12a-o to be deactivated. The purpose and operation of the input devices 22a-o will be described in greater detail below within the context of the disclosed verification methods.

The input devices 22a-o shown in FIG. 1 may be magnetic switches that are actuated by waving a magnetic key 24 in close proximity thereto. Such magnetic keys 24 may be made available to a designated system technician or group of designated system technicians. Limiting access to the input devices 22a-o in this manner is advantageous because it prevents unauthorized individuals from interfering with the verification of the alarm system 10. Various other types of input devices may be implemented without departing from the present disclosure. For example, the input devices 22a-o may include buttons or switches that can be actuated by any individual.

As previously mentioned, in a building, the installation of the plurality of notification appliances 12a-o and the plurality of initiating device 13a-j may include the running of a large quantity of wiring 20a-f between the various devices and the one or more alarm panels 14. In addition, the building 11 may also include other building systems such as, for example, HVAC system, security system, lighting control system, etc., which may also require the running of a large quantity of wiring between the various components in the system.

According to an embodiment of the present disclosure a solution to integrate these various systems with the fire alarm system 10, both from a physical infrastructure perspective and from a functional perspective, is disclosed. In use, these systems would preferably share wiring as well as some level of intelligence. For example, the other building systems and the fire alarm system 10 can use at least one common low voltage wiring.

For example, in use, the various other systems (e.g., HVAC, security, motion, cameras, pedestrian traffic monitors, Real-time location systems (RTLS), lighting control, wireless system, wireless repeaters, mesh network interfaces, etc.) could be powered by existing or modified fire alarm infrastructure such as Initiating Device Circuits (IDCs), Notification Appliance Circuits (NACs), Signaling Line Circuit (SLC), or proprietary networks (e.g. Ethernet). In addition to providing power, the fire alarm infrastructure could, at a minimum, communicate basic system-health and status information of the various other systems to the fire alarm panel 14.

In some embodiments, other remaining system-specific communication would not be processed by the fire alarm equipment, but may instead be passed directly to those systems using, for example, either a separate, parallel communication channel or a pass-through from the fire alarm system. That additional communication channel may be, for example, a completely separate wireless channel (e.g., Wi-Fi, Bluetooth, a custom wireless channel, a mesh network, etc.), or a layering of the channel on top of the primary fire alarm channel. A separate wireless channel may be point-to-point or a mesh network.

According to the present solution, increased efficiency and reduced cost may be realized by eliminating duplicative infrastructure (e.g., wiring), and allow for a combined maintenance and service solution. The present solution can enable a fire alarm system to provide a backbone wireless communication system and wired power delivery system to other electronic components.

In an embodiment, the present disclosure may be implemented by connecting a non-fire-alarm device directly to the fire alarm SLC, IDC, NAC, or proprietary network (e.g. Ethernet) wiring or any combination thereof. In one embodiment, the fire-alarm wiring may be a combined initiation and notification channel.

The functional requirements for this connection include: (1) the power interface must be designed such that the loading does not interfere with the circuit's normal operation, and (2) the communication interface must be compatible with the basic circuit or be separate from it (e.g. wireless).

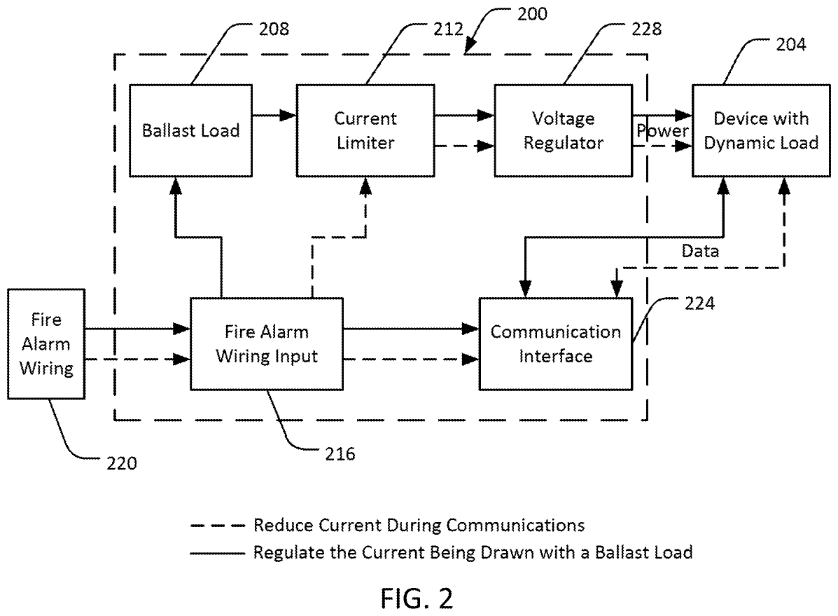

Referring to FIG. 2, a power interface 200 may be implemented with solutions to prevent interference with fire panel communications. The power interface solution may be implemented in a variety of ways.

In some embodiments, a device 204 (e.g., an HVAC device or other non-fire-alarm device) may become a static load when communication is occurring on a fire panel circuit 208 by either having a low power consumption or by temporarily lowering its power consumption responsive to detecting communication by the fire panel, such as by using a current limiter 212 coupled to fire panel wiring 220 via fire alarm wiring input 216. For example, the device 204 can cause a load when drawing power from fire panel wiring 220 in order to generate and transmit a communication signal, and the fire panel circuit 208 can make the load a static load. As shown in FIG. 2, the device 204 can be coupled to a voltage regulator 228 of the fire panel circuit 208 to receive power from the fire panel circuit 208, and to a communication interface 224 of the fire panel circuit 208 to receive data from and transmit data to the fire panel circuit 208.

In some embodiments, a ballast load 208 may be used to smooth the current being drawn from the fire panel wiring 220. For example, the connected equipment (device 204) may be designed such that the current consumption is inherently compatible by, for example, not consuming transient currents (not being a transient load), or by incorporating a “ballast load” which will consume a variable current. This variable ballast current would sense the dynamic current of the equipment (device 204), and in response, consume (waste) an amount of current to cause the total current to become static. As an example of this, if the equipment load alternated between 10 mA and 40 mA between its sleeping and active modes, then the ballast load would consume between 30 mA and OmA such that the resultant total current would be a continuous, static 40 mA. In some embodiments, the ballast load 208 can be selectively activated based on detecting that communication is not present, such that power is not wasted during non-critical states (e.g., when the fire alarm circuit is not communicating, and thus it may be unnecessary to waste power for the purpose of causing the total current to become static).

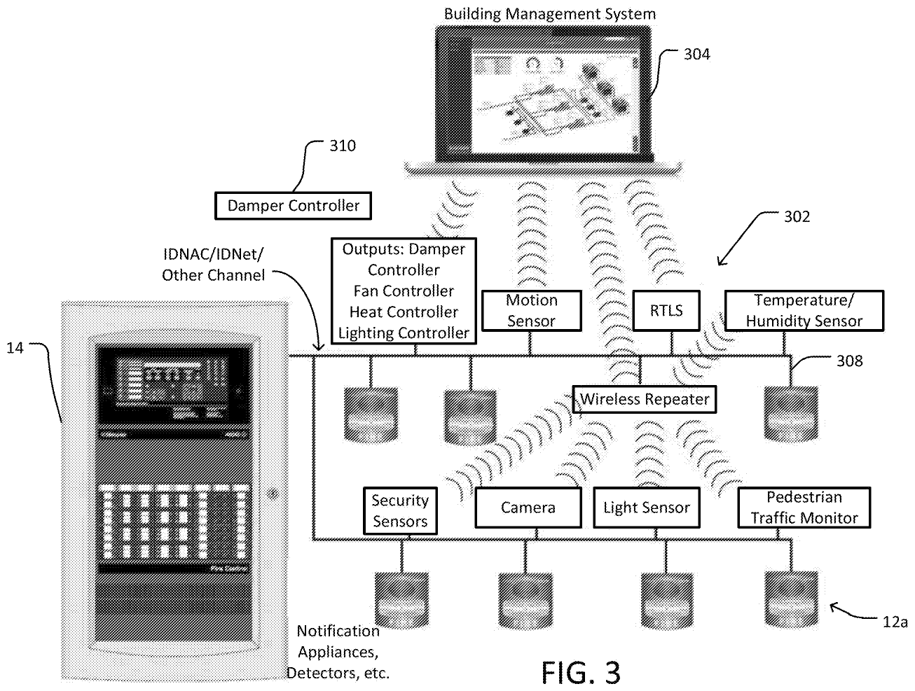

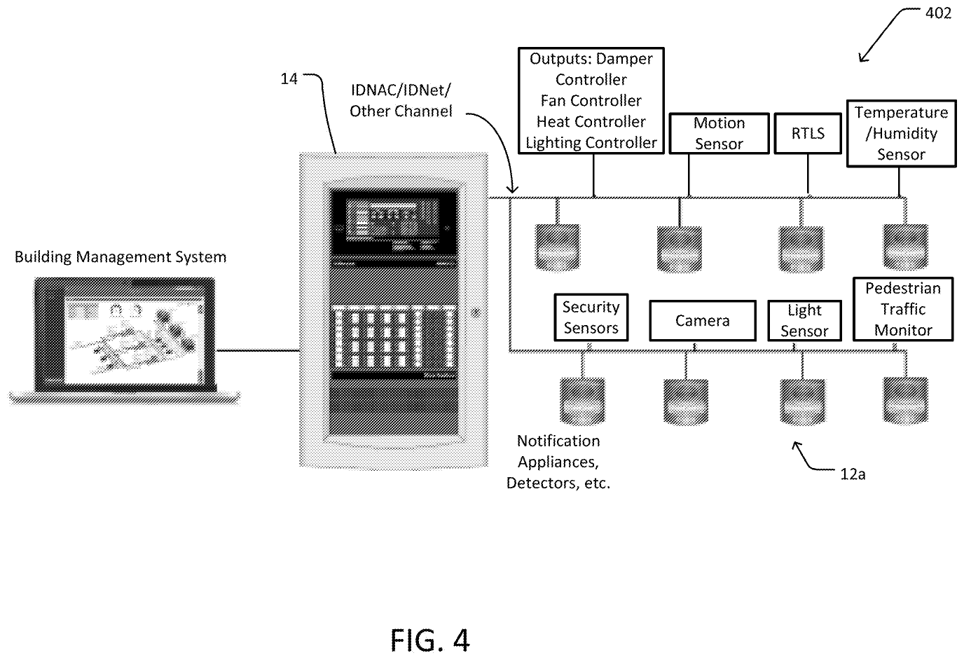

The communication interface 224 may be integral with the native characteristics (protocols and voltages) of the fire panel circuit, or a separate, not interfering channel. A non-interfering channel might be accomplished using an off-band frequency on the same wiring, or through a completely separate channel such as, for example, wireless. The communication interface 224 can transmit and receive data from the device 204, and by executing one or more of the solutions described herein, the power interface 200 can prevent communications by the communication interface 224 from interfering with critical communications by the fire alarm circuit that is providing power to the device 204. In some embodiments, one or more sensors (e.g., initiating device(s) 13a-j of FIG. 1; sensors and outputs 302 of FIG. 3; sensors and outputs 402 of FIG. 4) are in a same housing as the communication interface 224, such as by being mounted to a same backplane as a transceiver, control circuit, or other electronics of the communication interface 224. In some embodiments, the ballast load 208, current limiter 212, and voltage regulator 228 form a first path from the fire alarm wiring input 216 to the device 204, and the communication interface 224 forms a second path from the fire alarm wiring input 216 to the device 204.

Referring to FIG. 3, the present solution may be implemented by using the fire panel wiring (e.g., fire panel wiring 220 of FIG. 2) to power the other, alternate building systems. For example, sensors and outputs 302 may be powered by the fire panel 14, and they communicate wirelessly to a building management system 304, such as to communicate status information. Wireless communications can be passed through a wireless repeater that can also be powered by the fire panel 14. It will be appreciated that while the sensors and outputs 302 are illustrated as communicating via a loop 308 (e.g., circuit), one or more of sensors and outputs 302 may be provided on a separate loop and/or may be duplicated on or off the loop 308 (e.g., damper controller 310).

Referring to FIG. 4, the present solution may be implemented by connecting the fire panel wiring (e.g., fire panel wiring 220 of FIG. 2) to power other, alternate building systems. In various such embodiments, the sensors and outputs 402 may be powered by the fire panel 14, and may communicate using the same wiring. The building management system may be connected to the fire panel 14 to send and receive data from the sensors and outputs 402.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

What is claimed is:

1. A fire alarm system, comprising:
an alarm panel;
one or more notification appliances;
one or more initiating devices;
one or more wires coupling the alarm panel to the one or more notification appliances and to the one or more initiating devices; and
one or more alternate building systems coupled to the one or more wires, the one or more alternate building systems each including one or more components configured to receive power from the one or more wires.

2. The fire alarm system of claim 1, comprising:
the one or more alternate building systems transmit communication information over the one or more wires to the alarm panel.

3. The fire alarm system of claim 1, comprising:
the one or more alternate building systems include one of a HVAC system, a security system, and a lighting control system.

4. The fire alarm system of claim 1, comprising:
the one or more wires include at least one of an Initiating Device Circuits (IDCs), a Notification Appliance Circuits (NACs), Signaling Line Circuit (SLCs), and a proprietary network.

5. The fire alarm system of claim 4, comprising:
the one or more alternate building system is coupled directly to the IDC, NAC, SLC, or proprietary network wiring.

6. The fire alarm system of claim 1, comprising:
a power interface for the one or more alternate building systems configured so that a loading of the one or more alternate building systems does not interfere with normal operation.

7. The fire alarm system of claim 1, comprising:
at least one alternate building system communicates basic system-health and status information to the fire alarm panel.

8. The fire alarm system of claim 1, comprising:
the at least one alternate building system communications system-specific communications via an alternate communication pathway separate from the fire alarm panel.

9. The fire alarm system of claim 1, comprising:
an alternate communication pathway separate from and parallel to a communication channel between the at least one alternate building system and the fire alarm panel.

10. The fire alarm system of claim 9, comprising:
the alternate pathway is a pass-through from the fire alarm system.

11. The fire alarm system of claim 9, comprising:
the alternate pathway is a separate wireless channel.

12. The fire alarm system of claim 1, comprising:
at least one of the one or more initiating devices attached to a same backplane as at least one of the one or more notification devices.

13. A method of operating a fire alarm system, comprising:
receiving, at one or more alternate building systems, power from one or more wires, the one or more wires coupled to the one or more alternate building systems, the one or more wires coupling an alarm panel to one or more notification appliances and to one or more initiating devices; and
communicating, by the one or more alternate building systems, communication information over the one or more wires to the alarm panel.

14. The method of claim 13, comprising:
using a ballast load to smooth current drawn from the one or more wires for receiving power from the one or more wires.

15. The method of claim 13, comprising:
lowering power consumption, by the one or more alternate building systems, responsive to detecting communication by the alarm panel.

16. The method of claim 13, comprising:
communicating status information, by the one or more alternate building systems, to a building management system.

17. The method of claim 13, comprising:
the one or more alternate building systems include one of a HVAC system, a security system, and a lighting control system.

18. The method of claim 13, comprising:
the one or more wires include at least one of an Initiating Device Circuits (IDCs), a Notification Appliance Circuits (NACs), Signaling Line Circuit (SLCs), and a proprietary network.

19. The method of claim 13, comprising:
communicating, by the one or more alternate building systems, basic system-health and status information to the fire alarm panel.

20. The method of claim 13, comprising:
communicating, by the one or more alternate building systems, system-specific communications via an alternate communication pathway separate from the fire alarm panel.
